(19) United States
(12) Patent Application Publication
(10) Pub. No.: US 2016/0085980 A1
(43) Pub. Date: Mar. 24, 2016

(54) Information processing apparatus, imaging device, data management method and control program of photographed image

(71) Applicant: CANON KABUSHIKI KAISHA, Tokyo (JP)

(72) Inventors: Satoshi Imaizumi, Yokohama-shi (JP); Wataru Shimizu, Beijing-city (CN)

(21) Appl. No.: 14/857,221

(22) Filed: Sep. 17, 2015

(30) Foreign Application Priority Data
Sep. 22, 2014 (JP) 2014-192442
Oct. 2, 2014 (JP) 2014-203953

(51) Int. Cl. G06F 21/62; G06F 21/78; H04N 7/18

(52) U.S. Cl. CPC G06F 21/6209; H04N 7/185; G06F 21/78

(57) ABSTRACT

The present invention avoids execution of processing not intended by the user on the photographed image in a locked state. The image photographed by a camera which is in a lock released state is stored in a user area created in a storage area. On the other hand, an image photographed by a camera, which turned to a locked state as a result of being performed no operation for more than a fixed time, is stored in an area where stores the photographed image photographed in a locked state (second storage area). The image stored in the second storage area is determined after an input of a user's instruction with regard to the processing to be performed on the image.

### BACKGROUND OF THE INVENTION

1. Field of the Invention

The present disclosure relates to a technology adapted to an information processing apparatus comprising, for example, an imaging feature to individually manage an image photographed in a state in which feature or operation is restricted or a state without such restriction.

2. Description of the Related Art

In recent years, multifunctional device such as smart phones (hereinafter referred to as “smart device”) comprises an imaging feature. The smart device also comprises a lock feature which prevents execution of operation not intended by a user. The lock feature is a feature which is enabled if no operation is performed by the user for a fixed time. As a result, the smart device turns to a locked state. The locked state is released by entering a password or a passcode which is previously set by the user. When such a smart device is in a locked state, the user may miss a moment of photographing he wishes while he is entering the password. To solve such a problem, there is known a conventional technology in which, even the smart device is in a locked state, the imaging feature is started to perform photographing. Also, US Patent Application Publication No. 2012/0009896 discloses a technology in which application is started in a state where some of the features are disabled in a locked state, and which causes an authentication screen to display when accessing the disabled features.

It is noted that the imaging function is not physically disabled by the lock feature so that even the smart device is in a locked state, it is possible to perform photographing an image itself. Further, the image which is photographed in a locked state and the image which is photographed in an unlocked state are not differentiated from each other at all. This sometimes causes a case where processing not intended by the user is executed on the photographed image. For example, in a case where processing for automatically synchronizing an image photographed (hereinafter referred to as “photographed image”) with a server on a cloud is set in the smart device, the photographed image is synchronized with the cloud irrespective of the user's intention. As a result, some unnecessary communication is caused. Also, in a case where data on the cloud is set to be disclosed on a Web, there may be a case where the photographed image not intended by the user may be disclosed. Such problems are commonly caused in an information processing apparatus which allows photographing an image itself in a state where some feature other than the lock feature is restricted. This includes, for example, a state where usage is restricted by a device policy. In the device policy, features allowed or prohibited by the user are listed up. The user sets the device policy as he wishes. By doing so, it is possible to avoid circumstances in which unintended features are executed in the smart device.

### SUMMARY OF THE INVENTION

The present disclosure provides an information processing apparatus capable of obtaining data in either a first state in which feature or operation is restricted or a second state in which the restriction is released. The information processing apparatus comprises: a determining unit configured to determine whether the data is obtained in the first state or in the second state, a storing unit configured to individually store first data obtained in the first state and second data obtained in the second state in a predetermined storage medium; and a control unit configured to determine processing to be performed on data stored in the storage medium after an input of a predetermined instruction.

Further features of the present invention will become apparent from the following description of exemplary embodiments (with reference to the attached drawings).

### BRIEF DESCRIPTION OF THE DRAWINGS

FIG. 1 is a configuration diagram of an information processing apparatus according to a first embodiment.

FIG. 2 is a diagram explaining a processing procedure when photographing in accordance with the first embodiment.

FIG. 3 is a diagram explaining a processing procedure of an image stored in an area where stores the photographed image photographed in a locked state in accordance with the first embodiment.

FIG. 4 is an explanatory diagram showing the relation between a state of a camera and a storage destination according to the first embodiment.

FIGS. 5A to 5C are diagrams showing storage condition of the camera according to the first embodiment.

FIG. 6 is a corresponding diagram of an operation to be executed by a user on an image stored in the area which stores the photographed image photographed in a locked state and “determined/undetermined” to the operation.

FIG. 7 is a diagram explaining a processing procedure for storing a photographed image in a user area in accordance with a second embodiment.

FIG. 8 is a diagram explaining a processing procedure of an image stored in an area where stores the photographed image photographed in a locked state in accordance with the second embodiment.

FIG. 9 is an explanatory diagram showing the relation between a state of a camera and a storage destination according to the second embodiment.

FIGS. 10A to 10G are diagrams showing a state of a camera file system in accordance with the second embodiment.

FIG. 11 is a diagram explaining a processing procedure for obtaining log-in account information in accordance with a third embodiment.

FIGS. 12A and 12B are diagrams showing an example of the operation screen shown when processing an image stored in an area where stores the photographed image photographed in a locked state.

FIG. 13 is a hardware configuration diagram of an imaging device according to a fourth embodiment.

FIG. 14 is a software module configuration diagram of the imaging device.

FIG. 15 is an explanatory diagram showing setting example of device policy.

FIG. 16A shows an HTML comprising widget, and FIG. 16B shows program parts thereof.

FIGS. 17A to 17D are diagrams explaining widget screen.

FIG. 18A is a diagram explaining a processing procedure of JavaScript engine, and FIG. 18B is a diagram explaining procedure of photographing processing.

FIGS. 19A and 19B are diagrams explaining the contents of data base included in the JavaScript engine.

FIG. 20A is a diagram explaining procedure of decryption processing of an actual image, and FIG. 20B is a diagram explaining procedure of decryption processing.

FIG. 21 is a diagram illustrating a pop-up screen for prompting an operator for determination.

FIG. 22 is a diagram explaining the procedure to generate a dummy image.

### DESCRIPTION OF THE EMBODIMENTS

### First Embodiment

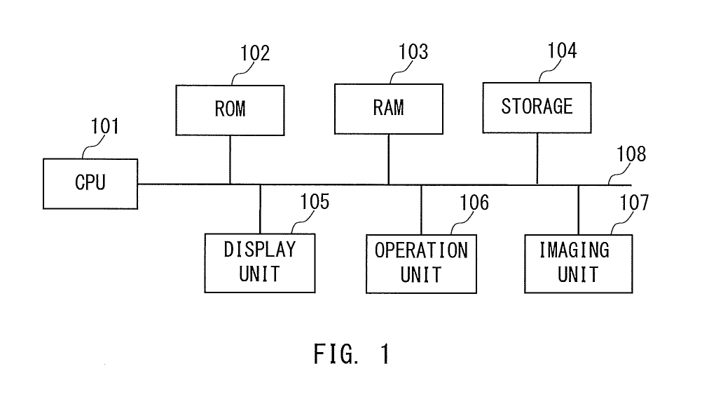

FIG. 1 is a configuration diagram of an information processing apparatus according to a first embodiment of the present invention. The information processing apparatus is a computer comprising a CPU (Central Processing Unit) 101, a ROM (Read Only Memory) 102, a RAM (Random Access Memory) 103, a storage 104, a display unit 105, an operation unit 106, and an imaging unit 107, which can reciprocally establish communication via a system bus 108. The ROM 102 is a read only memory which stores control program, various fixed data and the like of the present invention. The CPU 101 performs entire control of the information processing apparatus by reading and executing the control program. The RAM 103 is a rewritable memory comprising of a SRAM (Static Random Access Memory), a DRAM (Dynamic Random Access Memory) and the like. The RAM 103 is used as a work area of the CPU 101. Further, program control variables, various setting parameters, buffer used for various works and the like are stored in the RAM 103. The storage 104 is a non-volatile memory such as a hard disk, a semiconductor memory and the like. The display unit 105 is a display device used to display a notification to a user through an LCD (Liquid Crystal Display) and the like. The operation unit 106 is a keyboard, a pointing device and the like used by the user for various input operations. The operation unit 106 may be a touch panel which is integrated with the display unit 105. The imaging unit 107 is a built-in camera device for photographing an image (still image or moving image). It is noted that, in the following description, the imaging unit 107 (camera device) is simply called “camera”.

The information processing apparatus has a lock feature and a lock release feature. With the lock feature, a feature or an operation of the camera of the information processing apparatus is restricted (a first state). For example, the information processing apparatus is turned to a locked state similar to the conventional art by the lock feature. With the lock release feature, a feature or an operation of the camera of the information processing apparatus is released (a second state). For example, the locked state is released and the feature is turned to an unlocked state by the lock release feature. It means that, the first state is a state which requires user's authentication when restarting the feature or the operation of the imaging unit 107. The second state is a state in which the authentication is succeeding. It is noted that, regardless of whether the information processing apparatus is in a locked state or in an unlocked state, it is assumed that the camera is activated, which allows storing the photographed image. Also, it is noted that the information processing apparatus is available in a single-user environment or multiuser environment. Description will be given in the first embodiment with regard to an example in a case where the information processing apparatus is operated in the single-user environment.

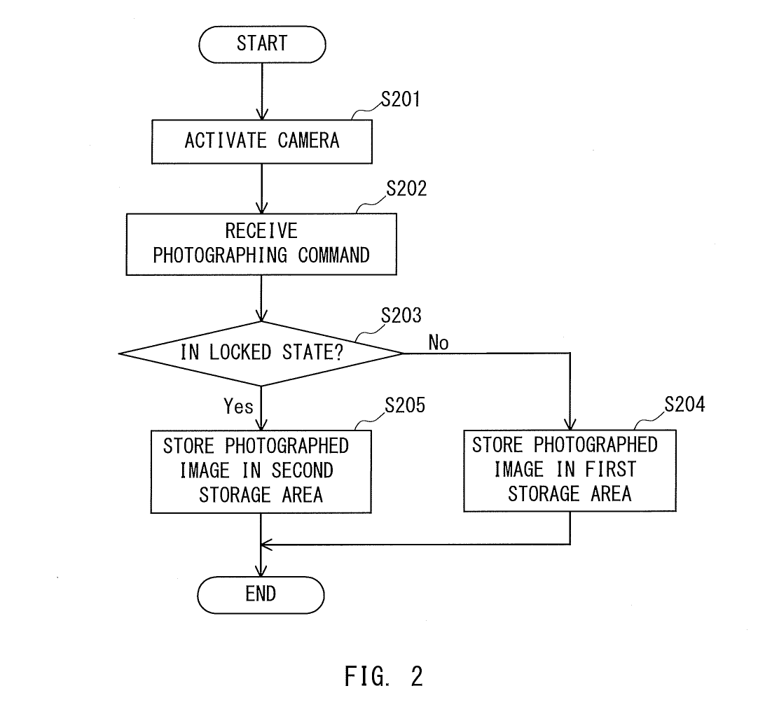

FIG. 2 is a diagram explaining procedure of entire processing executed by the CPU 101. The processing is started in response to an instruction to activate the camera by a button operation and the like. The CPU 101 activates the camera (S201). When the user turns on a predetermined switch or operates an icon of the camera feature from a menu screen displayed on the display unit 105, the camera is activated. When the camera is activated, the CPU 101 causes the display unit 105 to display an operation screen. The operation screen includes, for example, a live view screen, an operation menu of the camera and the like. When the user performs the photographing operation, the CPU 101 receives the operation as a photographing command (S202). The photographing operation is performed by pressing down a shutter button (not shown), and tapping a photographing icon displayed on the display screen of the display unit 105. In response to receiving the photographing command, the CPU 101 determines whether the camera is in a locked state or not (S203). It means that the CPU 101 works as a determination unit. If it is determined that the camera is in a locked state (S203: Y), the CPU 101 performs control such that the image to be obtained after the photographing command (a first photographed image) is stored in an area where stores the photographed image photographed in a locked state in the storage 104 (S205) and ends the processing. If it is determined that the camera is not in a locked state (S203: N), the CPU 101 performs control such that the image to be obtained after the photographing command (a second photographed image) is stored in a user area (S204) and ends the processing. It means that the CPU 101 works as a storage unit.

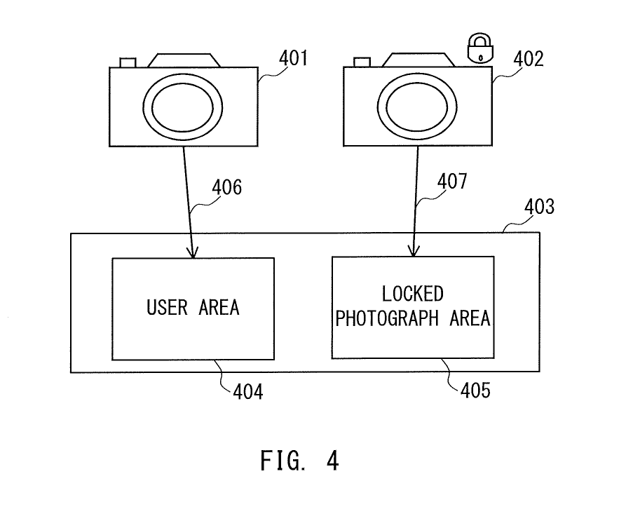

Here, description is given with regard to the locked photograph area and the user area with reference to FIG. 4. For convenience of explanation, FIG. 4 shows a camera, which is represented as a camera 401 being in an unlocked state, and a camera 402 being in a locked state. Further, it is conceptually shown in FIG. 4 that a storage area 403, which is part of the storage 104 shown in FIG. 1, for storing the photographed image has two areas. One is a user area 404, which is a user area. The other is a locked photograph area 405 where stores the photographed image photographed in a locked state. The two areas, i.e., the user area 404 and the locked photograph area 405 can be distinguished from each other by, for example, creating different folders. It means that, the user area 404 and the locked photograph area 405 are individually and distinctively created in the storage area 403. It is noted that, instead of creating two storage areas in one storage 104, respectively different storage media can be used as the user area 404 and the locked photograph area 405. The point is, as long as the first photographed image is stored in the storage area, where is different from where the second photographed image is stored, it can be configured in any configuration. An arrow 406 shows that the photographed image photographed when the apparatus is in an unlocked state is stored in the user area 404. Similarly, an arrow 407 shows that the photographed image photographed when the apparatus is in a locked state is stored in the locked photograph area 405.

The CPU 101 operates as a control unit which executes processing content instructed by the user on the photographed image stored in the storage 104. For example, the CPU 101 controls such that the processing to be performed on the photographed image stored in the locked photograph area 405 shown in FIG. 4 is determined after the input of the user's instruction.

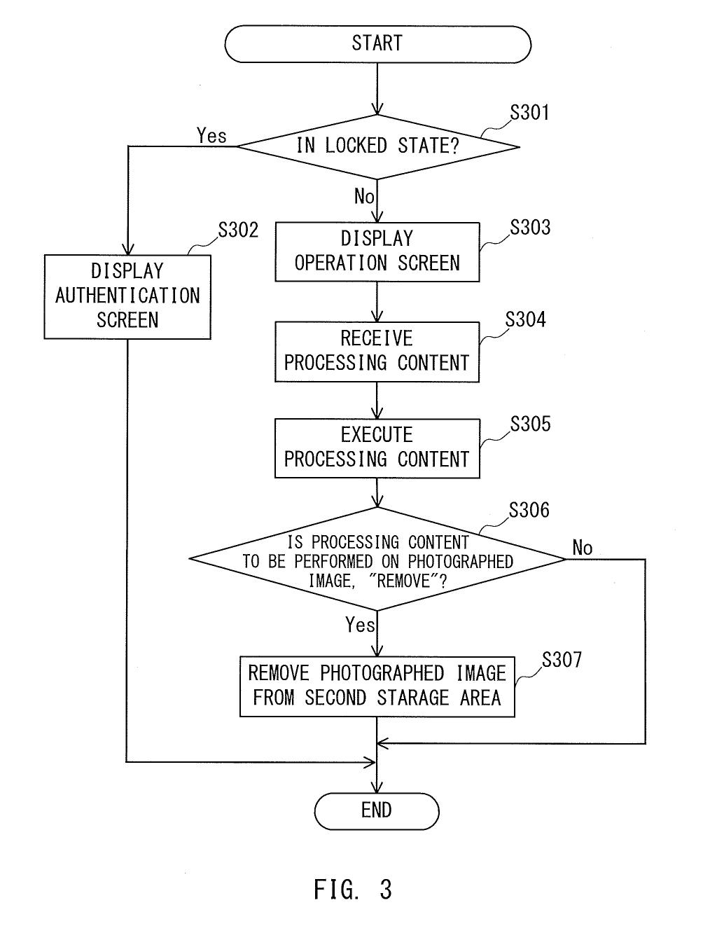

FIG. 3 is a diagram explaining a processing procedure relating to the processing to be performed on the photographed image. FIGS. 5A to 5C are state transition diagrams of the storage area 403 which changes in the process of the processing shown in FIG. 3. As shown in FIG. 5A, it is assumed that “image 1”, “image 2”, and “image 3” are stored in the storage area 403. It means that the “image 1” and “image 2” are stored in the user area 404 and the “image 3” is stored in the locked photograph area 405.

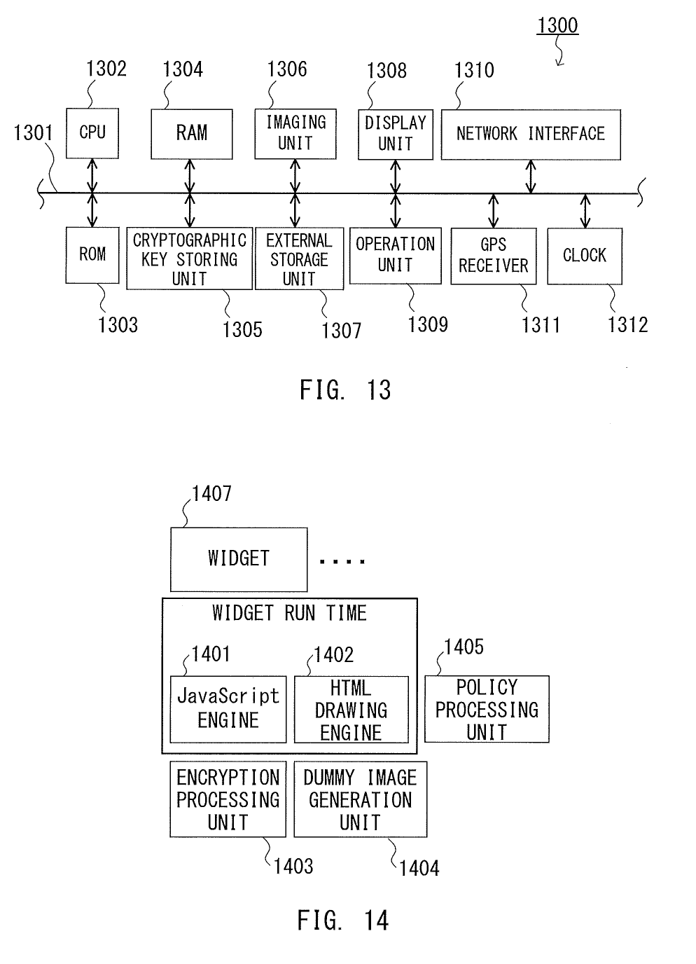

Description is given with regard to a processing procedure to be performed on the image stored in the locked photograph area 405 according to a first embodiment. The processing shown in FIG. 3 is started upon detection of the user's action performed on the information processing apparatus. The user's action includes, for example, pressing down a physical button of the information processing apparatus, detection of vibration satisfying a predetermined condition by a sensor, and the like. The CPU 101 determines whether the camera (or the apparatus) is in a locked state or not (S301). If it is determined that the camera is in a locked state (S301: Y), the CPU 101 displays an authentication screen for releasing the locked state (S302) and ends the processing. If it is determined that the camera is not in a locked state (S301: N), the CPU 101 causes the display unit 105 (S303) to display the operation screen for instructing the processing to be performed on the photographed image stored in the locked photograph area 405. Here, an operation screen 1201 shown in FIG. 12A is assumed to be displayed. The user selects a target photographed image in the operation screen 1201. The user also determines the processing content to be performed on the selected photographed image. In case of FIG. 12A, the photographed image to be selected is the “image 3”. The processing content is any one of “copy”, “remove”, and “cancel”. The “copy” means to copy the selected photographed image from the locked photograph area 405 to the user area 404. The “remove” means to remove the selected photographed image from the locked photograph area 405. The “cancel” means to do nothing on the photographed image.

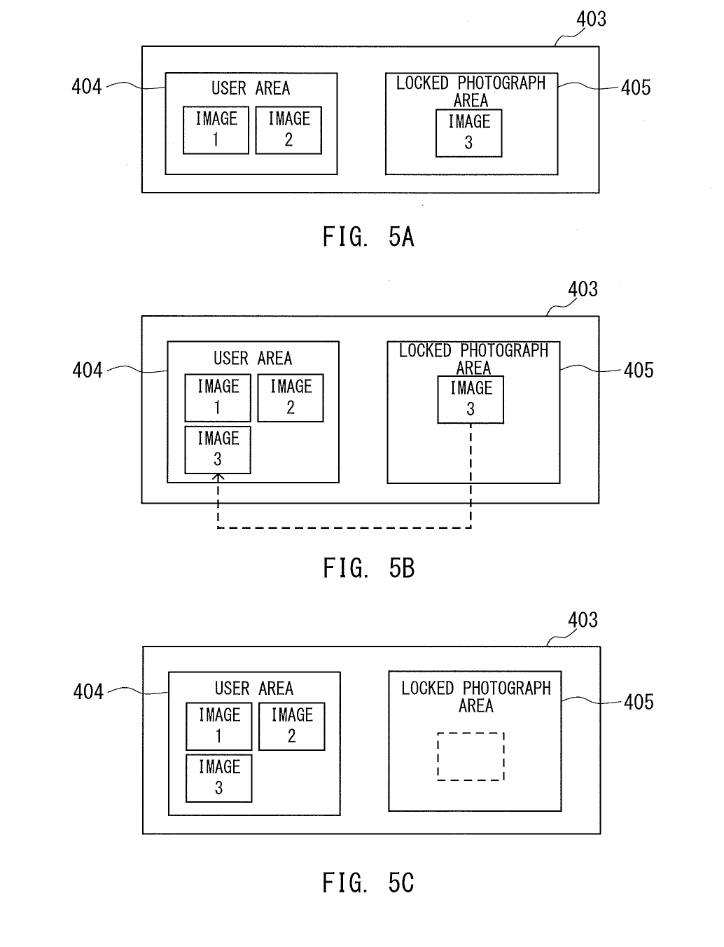

FIG. 6 is a table diagram indicating user's intention to the processing to be performed on the photographed image (processing content). An item of “determined/undetermined” in FIG. 6 represents whether the user decided the processing to be performed on the photographed image with intention or not. If the photographed image is necessary for the user, the user “determines” to copy the photographed image from the locked photograph area 405 to the user area 404. If the photographed image is not necessary for the user, the user “determines” to remove the photographed image from the locked photograph area 405. The “undetermined” means that the user's intention is not input yet.

Back to the processing of FIG. 3, the CPU 101 receives the processing content to be performed on the photographed image selected by the user as an input of an instruction (S304). Then, the CPU 101 executes the processing content received (S305). Here, it is assumed that “copy to the user area 404” is received as the processing content. The CPU 101 executes the processing to transfer the “image 3” stored in the locked photograph area 405 to the user area 404. FIG. 5B shows this state. Then, the CPU 101 decides whether the processing content performed on the “image 3” operated is “remove” or “determined” (S306). According to FIG. 6, “determined” is assigned to “remove” (S306: Y), therefore, the CPU 101 removes the “image 3” from the locked photograph area 405 (S307) and ends the processing. FIG. 5C shows this state. It is noted that the “image 3” stored in the locked photograph area 405 can be removed at any timing after copying the “image 3”. After executing the processing content, the CPU 101 stores the information indicating “processed” in relation with the “image 3”.

It is noted that, in the first embodiment, description has been given with regard to the example of distinguishing the first photographed image photographed in a locked state and the second photographed image photographed in an unlocked state by individually storing the photographed images in the storage areas. Description has also been given in the first embodiment with regard to the example of determining the processing to be performed on the first photographed image (processing content) after the input of the user's instruction. The present invention, however, is not limited to such examples. For example, information at the time of photographing which indicates that the image is photographed in a locked state may be stored in the storage 104 in relation with the first photographed image. That is, other configurations may be employed as long as the fact that the photographed image is photographed in a locked state can be verified afterwards. The information at the time of photographing at this time may be added to the property information formed when the image is photographed.

Description has also been given in the first embodiment with regard to the example of determining the processing to be performed on the photographed image stored in the locked photograph area 405. In the example, if the camera or the apparatus is determined to be in a locked state, the authentication screen is displayed and the processing is ended. However, the processing performed in the first embodiment is not limited in this way. If the authentication processing is succeeding, the processing subsequent to the step of S303 may be continued.

### Second Embodiment

In a second embodiment, description will be given in a case where the information processing apparatus as described in the first embodiment is used in the multiuser environment. The component of the information processing apparatus according to the second embodiment is similar to that of the information processing apparatus according to the first embodiment. In addition, the processing procedure at the time of photographing image is almost identical to that shown in FIG. 2. The difference is that the CPU 101 works as a management unit for holding account information of a plurality of user's who can log in. Along with this, processing contents performed by the CPU 101 when it works as the control unit differ from the first embodiment. In particular, the content of the step S204 shown in FIG. 2 differs. For example, processing content to be performed on the photographed image photographed in a locked state will be distinctly performed for each user. Also, each user will be given their own storage area.

In the second embodiment, the information processing apparatus in which two users are allowed to log in is used. It is assumed that the account information of each user is registered in the information processing apparatus. The account information is, for example, an ID consisting of text. In the second embodiment, the account information of one user is registered as “user A”, and the account information of the other user is registered as “user B”. The CPU 101 compares the account information registered with the account information input by the user when logging in for authentication. When the authentication is succeeding, the CPU 101 releases the locked state. In the following description, one user is referred to as user A and the other user is referred to as user B.

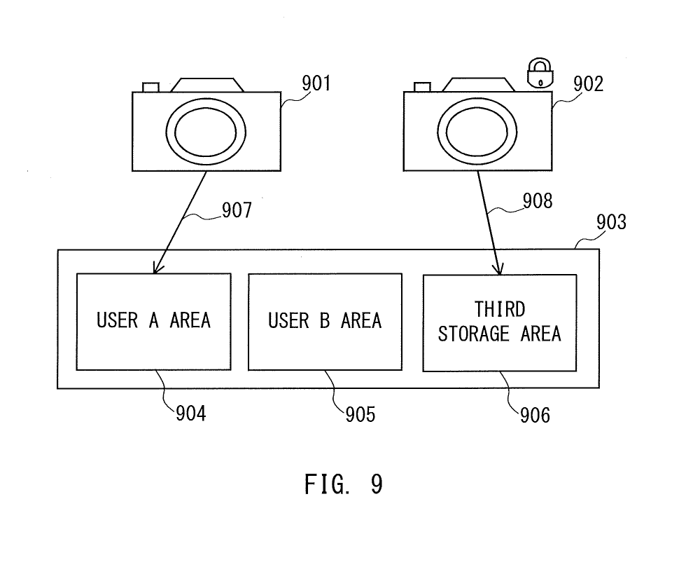

In the second embodiment, it is assumed that storage area, where corresponds to each account information and will be a storage destination of the photographed image, is reserved in the storage 104. The storage area used for the “user A” is defined as a “user A area”. Also, the storage area used for the “user B” is defined as a “user B area”. FIG. 9 shows the relation between these storage areas and the state of the camera. Similar to FIG. 4, in FIG. 9, one camera is represented as a camera 901, which is in an unlocked state, and a camera 902, which is in a locked state. That is, the photographed image photographed by the camera 901 which is in an unlocked state is stored in a user A area 904 in the storage area 903. Also, the photographed image photographed by the camera 902 which is in a locked state is stored in an area 906 where stores the photographed image photographed in a locked state (hereinafter referred to as a third storage area). A user B area 905 is a storage area corresponding to the “user B”, however, no photographed image is stored in the area. Based on this, in the following, processing contents to be performed on the photographed image photographed by the cameras 901 and 902 in each state will be described.

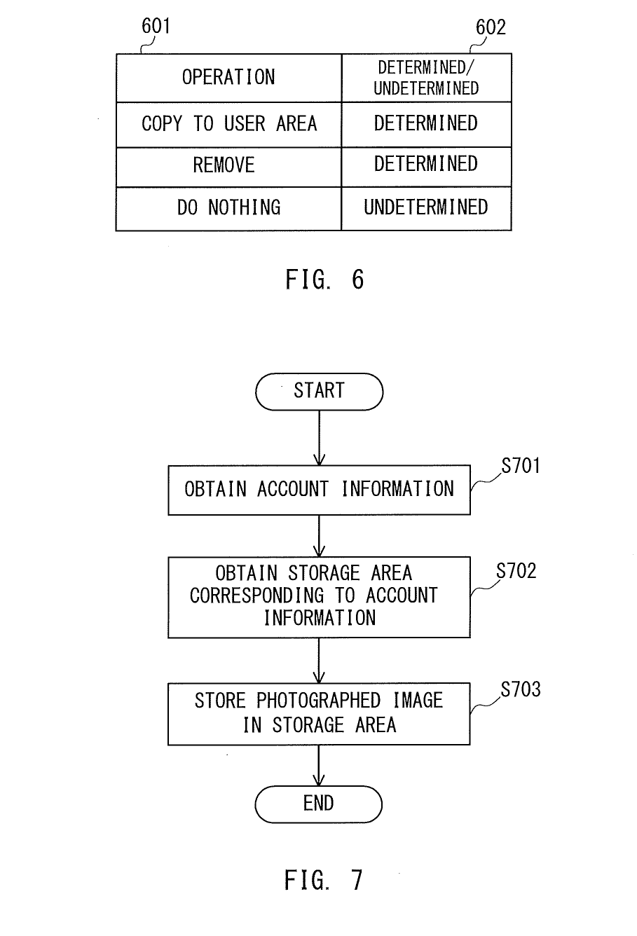

FIG. 7 is a diagram schematically explaining a procedure to store the photographed image. The processing shown in FIG. 7 is started upon completion of the user's login. The CPU 101 obtains the account information of the user who logged in (S701). When the account information is recognized, the CPU 101 obtains the storage area (“user A area”, “user B area”) corresponding to the account information (S702). Thereafter, the CPU 101 performs processing for storing the photographed image in the storage area (S703).

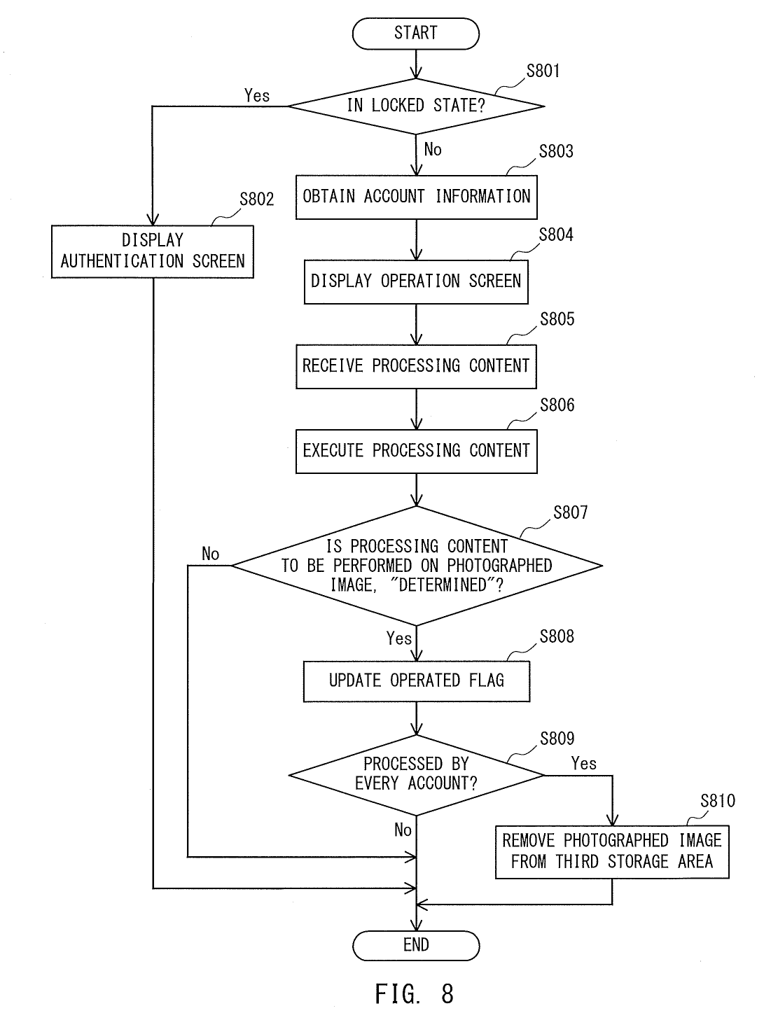

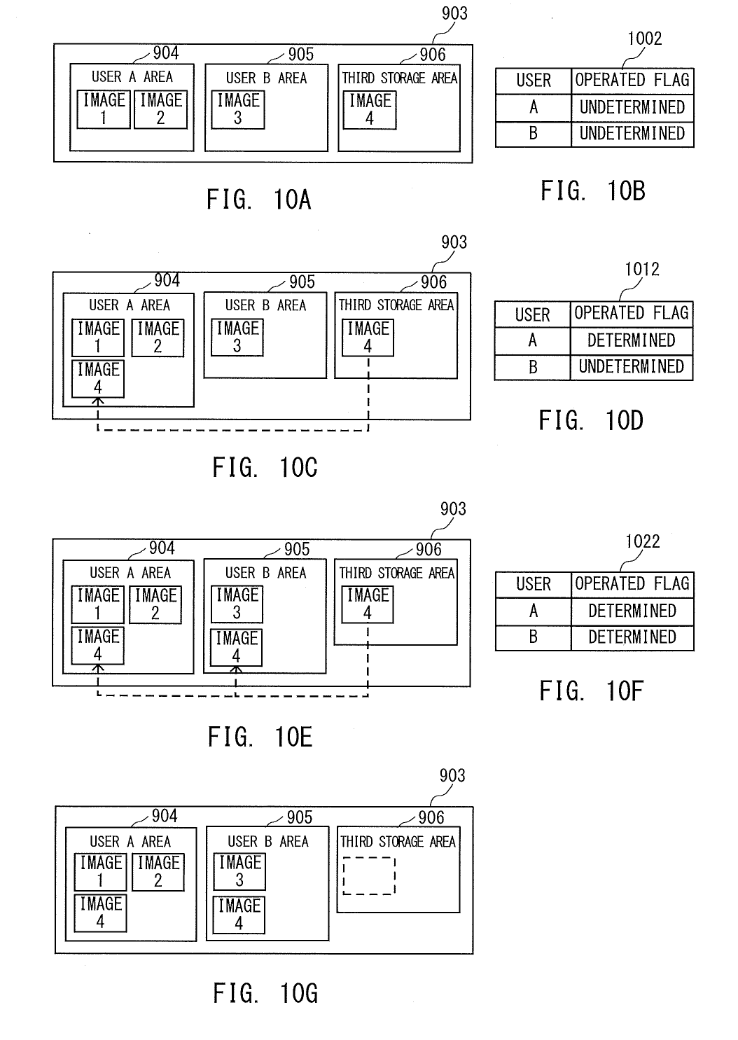

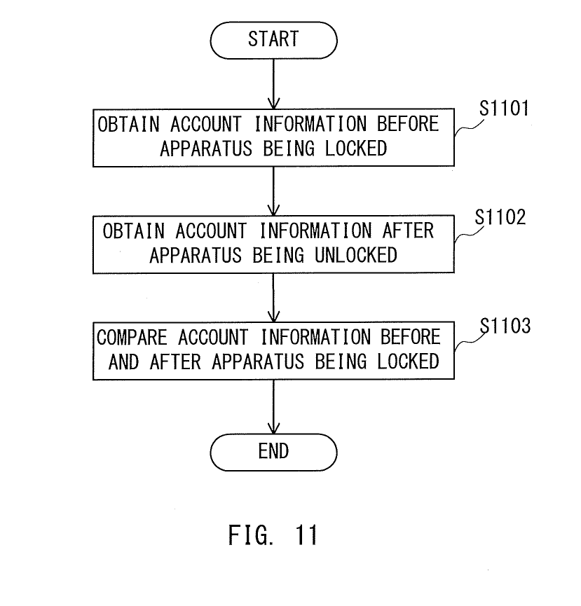

Next, description is given with regard to processing to be performed on the photographed image. FIG. 8 is a diagram for explaining an entire processing procedure. FIGS. 10A, 10C, 10E, and 10G are diagrams representing state transitions of the storage area 903 which changes in the process of processing shown in FIG. 8. FIGS. 10B, 10D and 10F are table diagrams indicating user's intention to the processing to be performed on the photographed image. First, it is assumed that the storage area 903 is turned to the state shown in FIG. 10A. The “image 1” and “image 2” are stored in the user A area 904. The “image 3” is stored in the user B area 905. The “image 4”, photographed in a locked state, is stored in the third storage area 906. FIG. 10B represents attachment information 1002 of the “image 4” stored in the third storage area 906. The attachment information 1002 represents operated flag information which represents the intention of the user A and the user B to the processing contents performed on the “image 4”. Similar to the embodiment shown in FIG. 6, there are three types of processing contents. In the table, “undetermined” represents a situation where each user is not determined yet. Also, “determined” represents a situation where each user is already determined. That is, it represents a situation where it is determined to copy the “image 4” from the third storage area 906 to the user A area 904 and the user B area 905 if the “image 4” is the photographed image necessary for each user.

Next, description is given with regard to a processing procedure in accordance with FIG. 8 in a case where “copy to the user's area” is instructed by the user A. In the present embodiment, the processing shown FIG. 8 is started upon detection of a user's action, such as pressing down a physical button, performed on the information processing apparatus. Similar to the first embodiment, the CPU 101 determines whether the camera is in a locked state or not (S801). If it is determined that the camera is in a locked state (S801: Y), the CPU 101 displays an authentication screen for releasing the locked state (S802). Thereafter, the CPU 101 ends the processing. On the other hand, if it is determined that the camera is not in a locked state (S801: N), the CPU 101 obtains the user's login account (S803). Here, the CPU 101 obtains the login account of the user A. When the login account is obtained, the CPU 101 displays an operation screen for instructing the processing content to be performed on the photographed image (S804). The CPU 101 also receives the processing content to be performed on the photographed image (S805). Similar to the first embodiment, the processing content is any one of “copy to the user's area”, “remove”, and “do nothing”. As to “determined”/“undetermined” to the operation content, if the user A determined that he needs the photographed image, “determined” is selected and if not, “undetermined” is selected.

Thereafter, the CPU 101 executes the processing content (S806). Here, the processing content of “copy to the user's area” is selected. Then, as shown in FIG. 10C, the CPU 101 copies the “image 4” stored in the third storage area 906 to the user A area 904. The CPU 101 also determines whether the processing to be performed on the “image 4” is determined by the processing content (S807). The processing content of “copy to the user's area” is the processing which determines the processing to be performed on the “image 4”. As the copy operation is done, as shown in FIG. 10D, the operated flag with respect to the user A is updated to “done” (S808). Thereafter, the CPU 101 determines whether the processing to determine the processing content to be performed on the target image is performed for each account (S809) or not. At this time, only the user A is performing the processing, i.e., operation by the user B for determining the processing content to be performed on the photographed image is not performed. Thereby, the CPU 101 leaves the “image 4” stored in the third storage area 906 as it is and ends the processing (S809: N).

Next, description is given with regard to processing when the user B logs in. At this time, the storage 903 is in a state shown in FIG. 10C. It is assumed that the user B is intended to copy and store the “image 4”, stored in the third storage area 906, in the user B area 905.

After the user B logged in, the processing of the steps S801 to S808 in FIG. 8 is performed, which is also performed to the user A. In the processing of S806, since the user B intends to “copy to the user area”, the “image 4” stored in the third storage area 906 is copied to the user B area 905. The resultant storage area 903 is shown in FIG. 10E. Also, as shown in FIG. 10F, through the operation of the step S808, the operated flag of the user B turns to “done”. Through the above, the processing to determine the processing contents to be performed on the target image is performed by every account (S809: Y), so that the CPU 101 removes the “image 4” from the third storage area 906 (S810). The resultant storage area 903 is shown in FIG. 10G.

As mentioned, according to the second embodiment, the processing content to be performed on the photographed image is switched depending on whether the camera is in a locked state or in an unlocked state. Then, the photographed image photographed when the camera is in a locked state and that photographed when the camera is in an unlocked state can separately be managed. Further, each user can control the photographed image stored in the third storage area 906 by managing the processing to be performed on the image photographed in a locked state by a unit of the user. Also, the photographed image can be removed upon completion of operation by each user.

### Third Embodiment

Similar to the second embodiment, in the third embodiment, the information processing apparatus in which a plurality of users are allowed to log in is used. Description is given here in a case where two user accounts, i.e., “user A” and “user B” are registered in the apparatus. It is assumed that the user A area 904 and the user B area 905 are reserved. The configuration of the information processing apparatus according to the third embodiment is similar to that in the second embodiment. It means that the CPU 101 works as a managing unit of the account information. Also, basically, the processing procedure at the time of photographing the image and the processing procedure of the image stored in the third storage area 906 are identical to those of the second embodiment. The difference is processing detail of the step S803, which is the processing to obtain the account information.

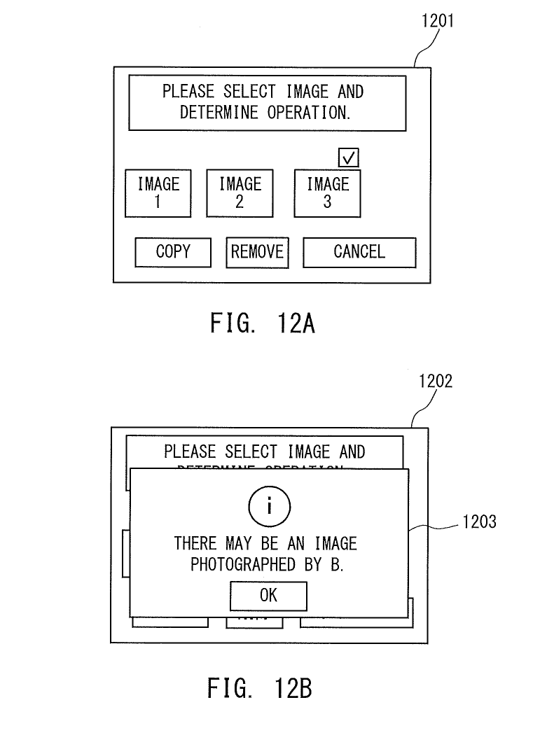

FIG. 11 is a diagram schematically explaining a processing procedure with respect to the account information in the third embodiment. The processing shown in FIG. 11 is started upon completion of lock release. In the third embodiment, two examples are used. One is an example in a case where the user A logged in before the apparatus is locked, thereafter, the apparatus turns to a locked state and then, the user A releases the locked state. The other is an example in a case where the user B logged in before the apparatus is locked, thereafter, the apparatus turns to a locked state and then, the user A releases the locked state.

First, description is given with regard to the first example. The CPU 101 obtains the account information of the last-logged in user before the apparatus is locked (S1101). In this example, the user A logged in before the apparatus is locked so that the account information of the user A is obtained. Thereafter, the CPU 101 obtains the account information of the user who released the locked state (S1102). In this example, the user A releases the locked state so that the account information of the user A is obtained. The CPU 101 compares the account information obtained in the step S1101 with that obtained in the step S1102 (S1103). In this example, two account information match so that the CPU 101 recognizes that the same user logged in. Then, the CPU 101 determines the processing content to be performed on the image stored in the third storage area 906 after the input of the instruction by the user A. FIG. 12A shows an example of a screen displayed in this example through the processing to display the operation screen in the step S804 in FIG. 8.

Next, description is given with regard to the second example. The CPU 101 obtains the account information of the user B in the step of S1101. Then, the CPU 101 obtains the account information of the user A in the step of S1102. The two account information do not match so that the CPU 101 recognizes that different users logged in before and after the apparatus is locked (S1103). In this case, the CPU 101 holds the processing content to be performed on the photographed image stored in the third storage area 906. FIG. 12B shows a screen 1202, which is displayed by the processing of the step S804 in FIG. 8 in this example. That is, a message 1203, indicating that the user B may have performed photographing in a locked state, is displayed. This enables to prevent determination of the processing content not intended by the user B.

As mentioned, according to the third embodiment, by comparing the account information before and after the apparatus is locked, when processing the photographed image photographed in a locked state, it is possible to avoid a situation where the photographed image photographed in a locked state by a different user is mistakenly removed. It is possible, for the user B, to avoid a situation where the processing not intended by the user B is performed on the photographed image.

[Variation 1]

Descriptions have been given in the first to the third embodiments with regard to the embodiments of the information processing apparatus comprising the imaging device. The present invention, however, can be implemented by various embodiments. For example, the information processing apparatus may be implemented as an imaging device comprising the determination unit, the storage unit, and the control unit as mentioned. At that time, the information processing apparatus may comprise the display unit 105 for displaying the operation screen for operating the first photographed image. In this case, the control unit is configured to receive the processing content to be performed on the first photographed image input by the user through the operation screen. Further, the control unit executes the processing content received.

[Data Management Method 1]

The present invention can be implemented as a data management method for managing, for example, the photographed image. The data management method includes the following processes executed by the information processing apparatus or the imaging device as mentioned above. (1) Process to determine a state of the imaging unit 107 at the time of photographing, the imaging unit 107 being capable of photographing the image by the user in both a locked state and an unlocked state. (2) Process to individually store the first photographed image photographed when the imaging unit 107 is in a locked state and the second photographed image photographed when the imaging unit 107 is in an unlocked state in the storage 104. (3) Process to determine the processing content to be performed on the first photographed image stored in the storage 104 after the input of the user's instruction.

### Forth Embodiment

Next, description is given with regard to an embodiment of the information processing apparatus which further performs policy control. To perform the policy control, the device policy, in which features allowed or prohibited in the application installed in the smart device are listed up, is prepared in advance. Then, it is determined whether the feature executed by the application is allowed or not by the device policy. If the feature is not allowed, the operation is controlled. The user sets the device policy as he wishes. By doing so, it is possible to avoid circumstances where any feature not intended by the user is executed by the application.

The device policy is sometimes changed by the user's intention. For example, there is sometimes a case where the user wishes to execute the application which is developed by a less reliable developer. In such a case, the user tries such application after deactivating all features except for minimum required features. In such a case, the user needs to change the device policy and reset the device policy later. However, the user sometimes misses timing to use features such as photographing a still image or a moving image, recording sound and the like while he is resetting the device policy. There is an appropriate timing for photographing and recording so that the user may miss such timing while he is resetting the device policy. Thereby, it is desirable to allow immediate execution of photographing, recording and the like, which are the features that place importance on real time responsiveness (allow reliable and immediate execution in response to the user's operation) if the user actually wishes to execute such features. On the other hand, photographing or recording feature needs to be controlled by the device policy.

Then, description will be given in the fourth embodiment with regard to the information processing apparatus which allows immediate execution of the features that place importance on real time responsiveness even in a feature restricted state, while reducing security task associated with the execution. The information processing apparatus realizes a system for reducing the security risk of the data obtained in the feature restricted state without changing any design of an access source of the data. The information processing apparatus can be implemented as a smart device comprising the imaging feature as mentioned, as an electronic device which is connected to the imaging device, and as a single imaging device. In this embodiment, an example is shown in a case where the information processing apparatus is implemented as the imaging device.

FIG. 13 is a hardware configuration diagram of the imaging device. Various functional components are connected to the imaging device 1300 via a system bus 1301. The functional components include a computer comprising a CPU 1302, a ROM 1303, a RAM 1304, and an external storage unit 1307. By executing the computer program of the present invention, the CPU 1302 operates as a control unit for controlling an entire operation of the imaging device 1300, especially, for controlling data storage. The ROM 1303 is a non-volatile memory which stores programs or parameters which do not require any change. The RAM 1304, used as a work memory of CPU 1302, temporarily stores the program and various data. The external storage unit 1307 is a hard disk, a semiconductor memory and the like. The external storage unit 1307 may be a removable flash memory, an IC card and the like. In this case, the imaging device 1300 has a removable mechanism of the memory. The ROM 1303, the RAM 1304, and the external storage unit 1307 operate as a storage unit which is realized by the control of the CPU 1302.

As the functional component connected to the system bus 1301, the imaging device 1300 also comprises a cryptographic key storing unit 1305, an imaging unit 1306, a display unit 1308, an operation unit 1309, a network interface 1310, a GPS receiver 1311, and a clock 1312. The cryptographic key storing unit 1305 stores key information necessary for encryption and decryption. The imaging unit 1306 is a built-in camera used to photograph a still image and a moving image. The imaging unit 1306 outputs photographed data as digital data. The digital data is compressed as necessary. The display unit 1308 is a display device such as a liquid crystal display (LCD). The operation unit 1309 is an operation unit such as a button or keyboard used by an operator (usually, user of the apparatus) for operating the apparatus. If the display unit 1308 has a touch panel feature, the display unit 1308 and the operation unit 1309 can be realized by the same device. The network interface 1310 is a mechanism for transmitting and receiving data to and from the network. The GPS receiver 1311 receives radio wave of GPS (Global Positioning System) satellite to determine a current position. The clock 1312 outputs current date and time. Also, it supplies operation clock of CPU 1302 etc.

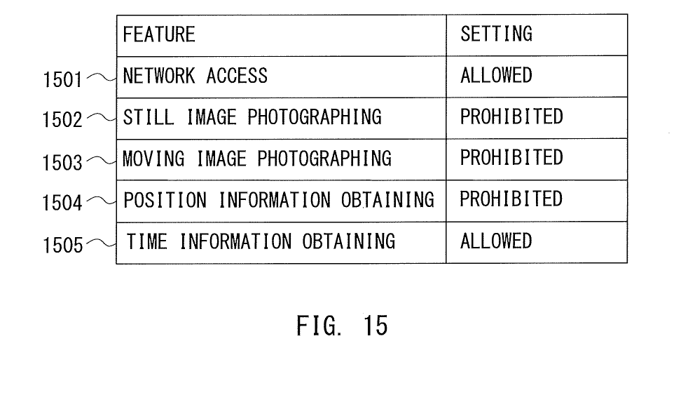

Among the functional components as above, the CPU 1302 forms various software modules in the imaging device 1300 by reading and executing the computer program of the present invention. FIG. 14 is a configuration diagram of a software module of the imaging device 1300 according to the fourth embodiment. The imaging device 1300 operates as a JavaScript engine 1401 which translates and executes programs written in JavaScript (R). The imaging device 1300 also operates as an HTML (Hyper Text Markup Language) drawing engine 1402 which displays data written in HTML (HTML data) on the display unit 1308. A downsized application called “widget” can be realized by writing an appearance in the HTML and an operation in the JavaScript. Also, what the JavaScript engine 1401 and the HTML drawing engine 1402 are put together is called “widget run time”. The widget run time is a management module which is at least required to operate the widget. The operation of the widget is controlled by the widget run time. In the following description, the widget and the widget run time are simply referred to as application if it is not necessary to distinguish two of them.

The HTML drawing engine 1402 handles the HTML data. The HTML data complies with a standard specification. On the other hand, the JavaScript engine 1401, implementing some features determined by the standard specification, further implements some additional features. This is described in the following description. An encryption processing unit 1403 encrypts and decrypts data using key information to which no access from the access source to the data is allowed (i.e., the key information stored in the cryptographic key storing unit 1305). As a result, tamper resistance is given to the data. A dummy image generation unit 1404 generates a dummy image which is one example of alternate data. The dummy image is not the photographed image photographed by the imaging unit 1306. It is the image generated so as not to cause any problem even when the image is flowed out to the network. A policy processing unit 1405 operates as a policy holding unit for holding security policy. The security policy is to define apparatus features (features included in the imaging device 1300, the same applies hereinafter) which are available/unavailable to the application. The processing relating to setting, changing, and determining compatibility of the security policy is also performed by the policy processing unit 1405. In the following description, the security policy is referred to as “device policy”.

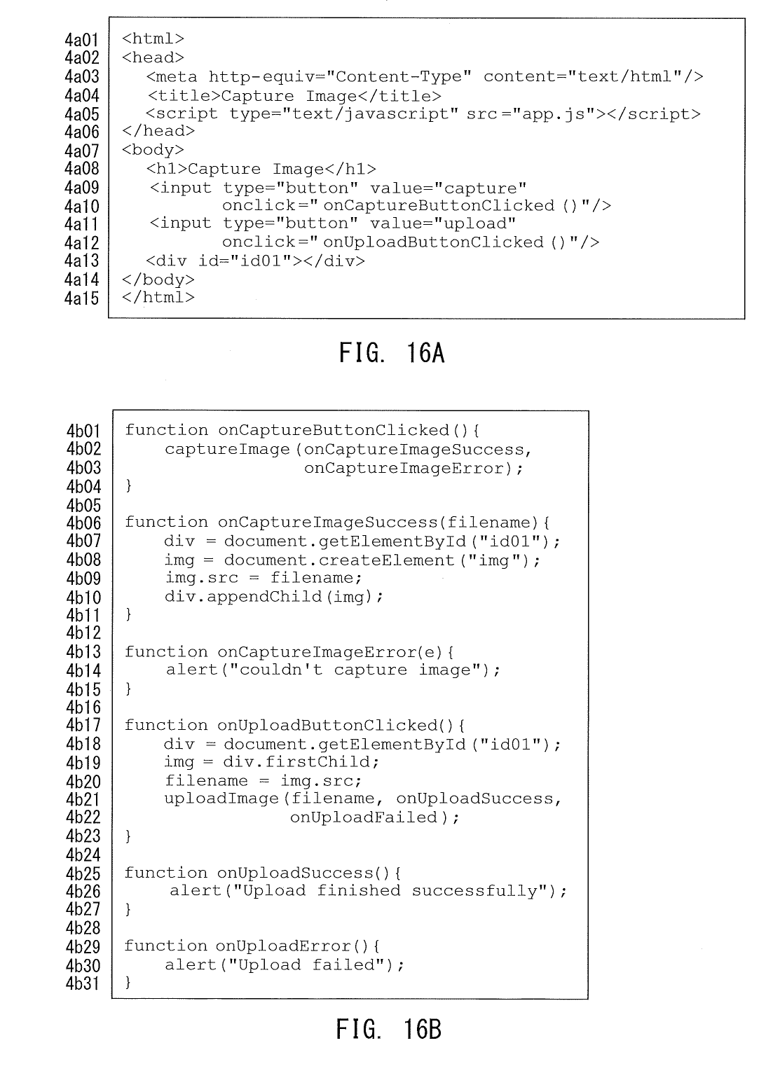

The operator or user of the imaging device 1300 can control the apparatus features available to the application. This is realized by setting and appropriately changing the device policy through the operation unit 1309 by the user. A concept of the device policy is described with reference to FIG. 15. The device policy consists of features (left column in FIG. 15) and settings (right column in FIG. 15) which correspond to the respective feature. The settings include “allowed” and “prohibited”. It is noted that any one of “allowed”, “prohibited”, and “fully prohibited” can be selected for a photographing feature, which is one of the apparatus features. The device policy may be more complicated. For example, there is a case where conditional execution is performed depending on a state of the apparatus (such as allowing photographing only when the user is in a particular place). In the example shown in FIG. 15, features of network access 1501 and time information obtaining 1505 are allowed. On the other hand, features of still image photographing 1502, moving image photographing 1503, and position information obtaining 1504 are prohibited.

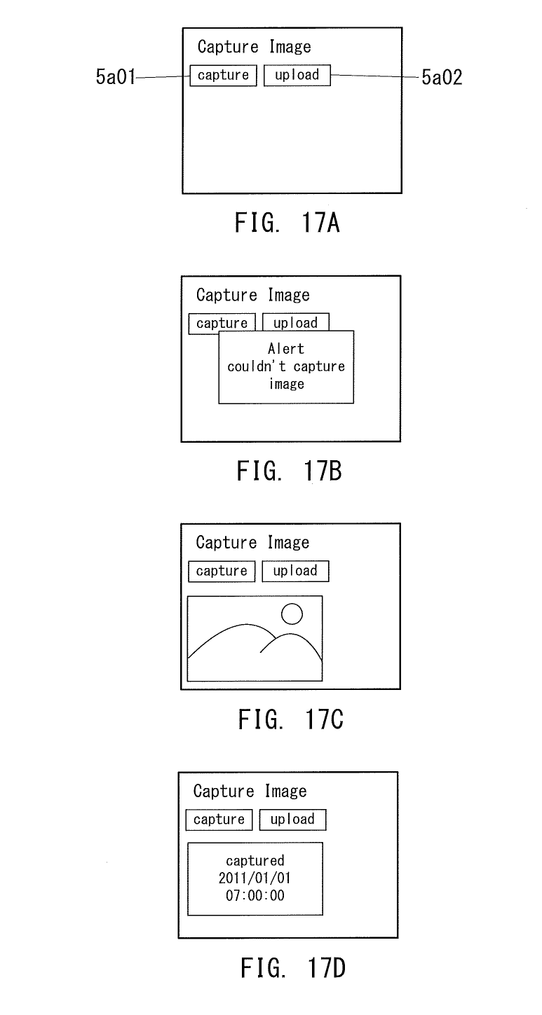

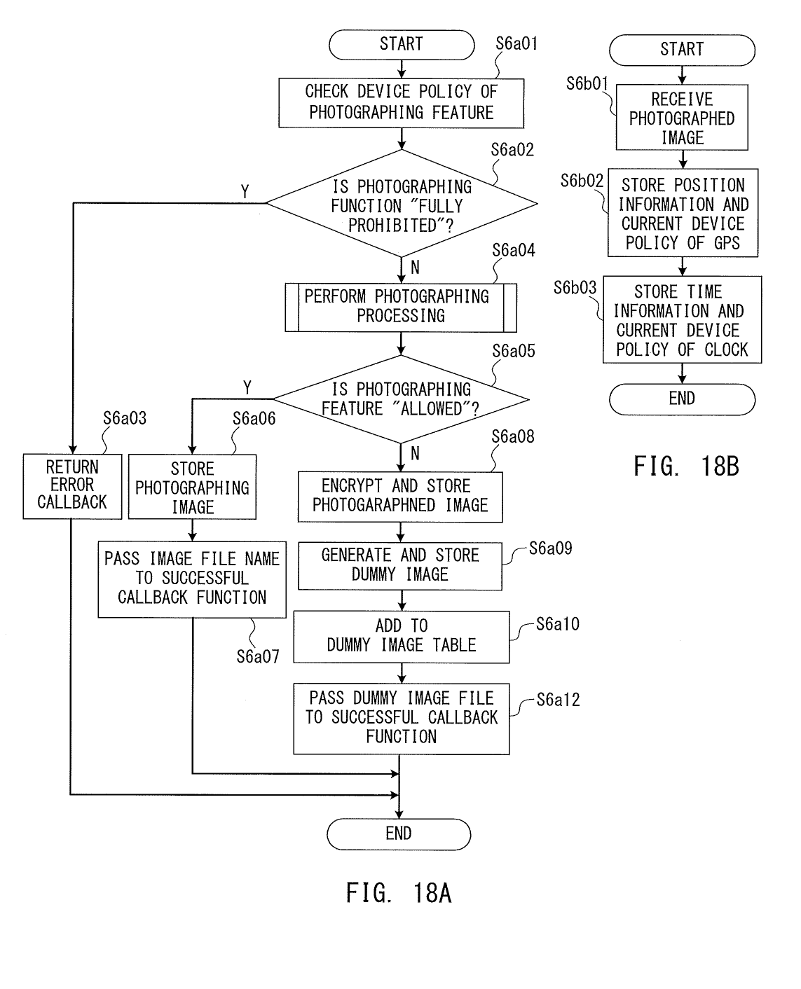

FIGS. 16A and 16B show an example of the application installed to perform photographing in the imaging unit 1306. FIG. 16A is an HTML file in which arrangement of the buttons is defined. FIG. 16B is a JavaScript file in which processing of the application is written. Both the HTML and the JavaScript are the standardized specification so that detail description thereof is omitted, but in brief, when the CPU 1302 reads and executes the HTML file shown in FIG. 16A, a screen shown in FIG. 17A is displayed on the display unit 1308. For example, an input tag of 4a09 in FIG. 16A represents a “capture” button 5a01 in FIG. 17A. Also, an input tag of 4a11 in FIG. 16A represents an “upload” button 5a02 in FIG. 17A. An onclick attribute is described in the input tag. This is the description of operation when the displayed button is pressed. It means that, when the “capture” button 5a01 is pressed, onCaptureButtonClicked function is called. Similarly, when the “upload” button 5a02 is pressed, onUploadButtonClicked function is called. These functions are defined in the JavaScript file shown in FIG. 16B.

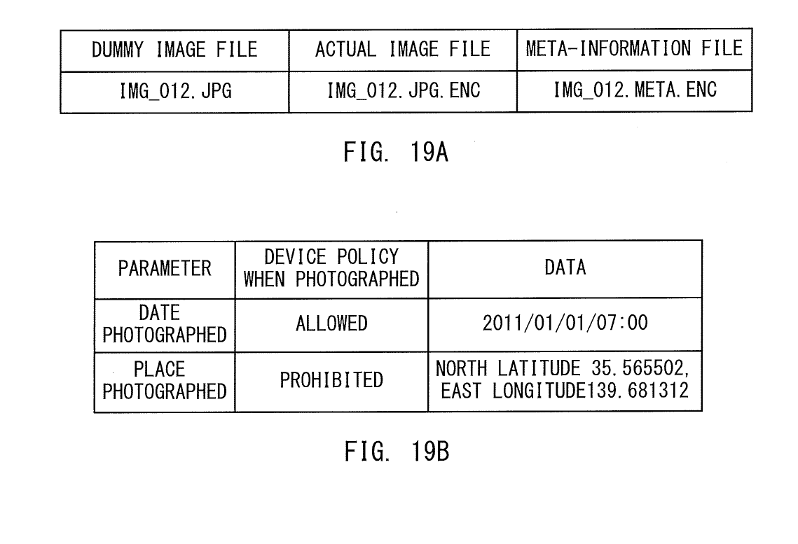

That is, this is the application which requests to obtain first data or second data (“capture” or “upload”) and executes subsequent processing after obtaining the result of the request. First, description is given with regard to a case where the user performs photographing using the application, i.e., with regard to the operation of the imaging device 1300 when the “capture” button 5a01 is pressed by the user. When the “capture” button 5a01 is pressed, the CPU 1302 of the imaging device 1300 calls the onCaptureButtonclicked function. The function is defined from 4b01 to 4b04 in FIG. 16B. That is, CaptureImage function, which is in FIG. 16B, 4b02, is called. The function is not included in the standard JavaScript specification, i.e., it is a feature specific to the JavaScript engine 1401. Then, description is given with regard to an operation example of the feature with reference to FIG. 18.

First, the CPU 1302 checks the device policy in the policy processing unit 1405 to determine whether the photographing feature is available or not (S6a01). The policy of the photographing feature is any one of “allowed”, “prohibited”, and “fully prohibited”. If the device policy of the photographing feature, “fully prohibited” is selected (S6a02): Y, the CPU 1302 does not perform photographing but returns an error callback instead (S6a03). That is, the CPU 1302 calls onCaptureImageError function, which is in FIG. 16B, 4b13. As a result, as shown in FIG. 17B, an alert is displayed on the display unit 1308. In this case, the subsequent processing cannot be executed. On the other hand, if the policy of the photographing feature, “allowed” or “prohibited” is selected, i.e., other than “fully prohibited” is selected, the CPU 1302 can perform the photographing processing (S6a04).

FIG. 18B shows the procedure of the photographing processing. That is, the CPU 1302 receives the photographed image photographed in the imaging unit 1306 (S6b01)

At this time, meta-information accompanying the photographed image is obtained. In particular, the CPU 1302 obtains position information from the GPS receiver 1311 to obtain current time from the clock 1312 (meta-information obtaining unit). It is noted that the meta-information is not limited to the above. For example, information with regard to setting at the time of photographing (zoom and white balance) or name of a photographer may be used as the meta-information. Thereafter, the CPU 1302 stores the meta-information in the external storage unit 1307 in relation with the photographed image (S6b02, S6b03). That is, the CPU 1302 and the external storage unit 1307 operate as the storage unit for storing the photographed image and the like. In the present embodiment, the photographed image obtained when the device policy of “prohibited” is selected is defined as first data. Also, the photographed image obtained when the device policy of “allowed” is selected is defined as second data. Further, the meta-information accompanying the first data is referred to as first meta-information. Also, the meta-information accompanying the second data is referred to as second meta-information.

It is noted that, depending on the device policy of the photographing feature, a way of storing each data and the processing contents to be performed thereafter on each data by the storing unit will vary. If the photographing feature is “allowed” (S6a05: Y), the CPU 1302 stores the second data and the second meta-information in the external storage unit 1307 in a format which allows an optional access by the application (S6a06). Then, the CPU 1302 calls successful callback, i.e., the CPU 1302 calls (and presents it to the user) onCaptureImageSuccess function using the file name at that time. The detailed description of the processing of the function is omitted because it is a feature within the scope of the standard specification, but in brief, the function is to display the second data corresponding to the file name presented on the screen. As a result, as shown in FIG. 17C, the second data is displayed on the display unit 1308.

On the other hand, if the photographing feature is “prohibited” (S6a05: N), the CPU 1302 gives the tamper resistant to the first data and stores the data in the external storage unit 1307 thereafter (S6a08). The tamper resistant is given by encrypting the first data using the key information. The key information is the information to which no access from the access source is allowed. If the first meta-information accompanying the first data is obtained, the meta-information is encrypted together with the first data. The key information only exists in the cryptographic key storing unit 1305 so that the feature of encryption will be the feature specific to the apparatus.

Also, the CPU 1302 generates a dummy image which is used as alternate data of the first data. Then, the CPU 1302 stores the dummy image in relation with the encrypted first data (S6a09). The dummy image is data presented to the application, which is the access source, as an alternative to the first data. As long as it is not the first data, the dummy image may be any data. Here, as shown in FIG. 17D, the dummy image is a character image representing date photographed. In the following, as compared to the dummy image, the first data or the second data may be called as an actual image.

When the dummy image is generated, the CPU 1302 adds a dummy image file, and the actual image file and the meta-information (the first meta-information) corresponding to the dummy image file to a dummy image table (S6a10). The dummy image table includes contents illustrated in FIG. 19A. In the following, the dummy image file, the actual image file, and the meta-information file in FIG. 19A will be described. The dummy image is collected into a file which is identified by specific identification information, which is the dummy image file. The actual image is collected into a file which is identified by specific identification information, which is the actual image file. The dummy information is collected into a file which is identified by specific identification information, which is the meta-information file. The meta-information file includes contents illustrated in FIG. 19B. Here, a parameter name, device policy at the time of photographing, and data are stored.

Thereafter, the CPU 1302 passes the file name of the dummy image file to a successful callback function as an argument (S6a12). That is, instead of the first data, the dummy image (alternate data) is presented. As a result, instead of the first data (actual image), the dummy image is displayed on the display unit 1308 as shown in FIG. 17D. Even the dummy image is displayed, the application recognizes this as a result of successful photographing. As a result, the subsequent processing in the application is executed. As mentioned, if the photographing feature is not “fully prohibited”, photographing itself is allowed and some sort of image can be displayed on the display unit 1308.

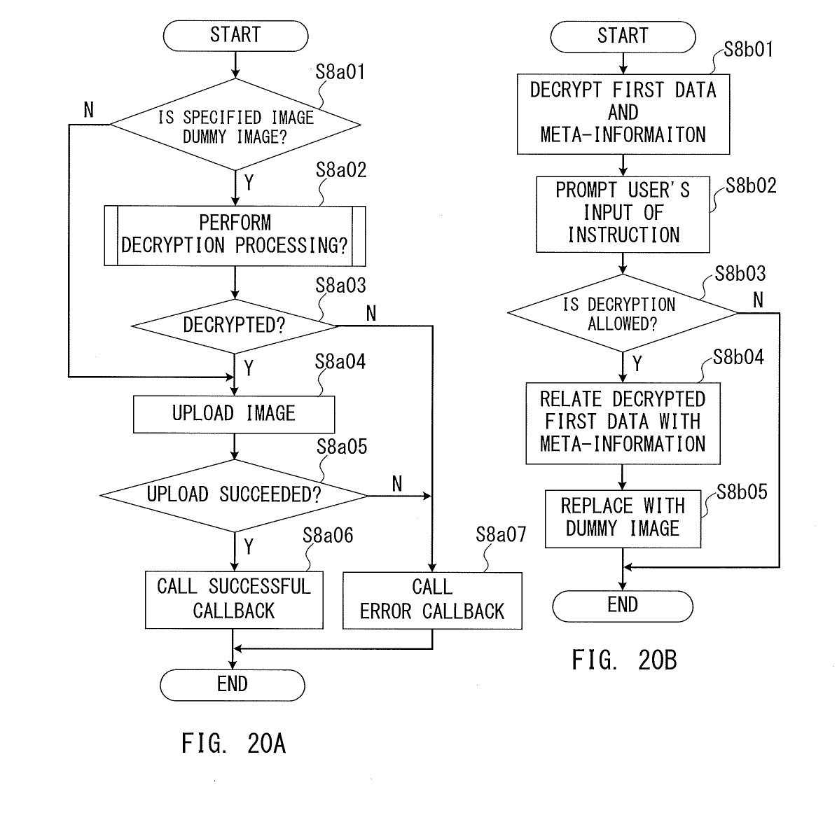

Here, assume that the user clicked “upload” button 5a02 of the screen displayed in the FIG. 17D. Upon detection of the user's button click, the CPU 1302 executes onUploadButtonclicked function. The function is defined from 4b17 to 4b22 in FIG. 16B. In FIG. 16B, 4b18 to 4b20 represent features within the standard specification so that the detail description thereof is omitted, but in brief, the description from 4b18 to 4b20 means to upload the dummy image file passed in the step of S6a07 or S6a12 to a server. The CPU 1302 uploads the dummy image file by uploadImage function (4b21). The function is the feature specific to the device. Then, the processing procedure is described with reference to FIG. 20.

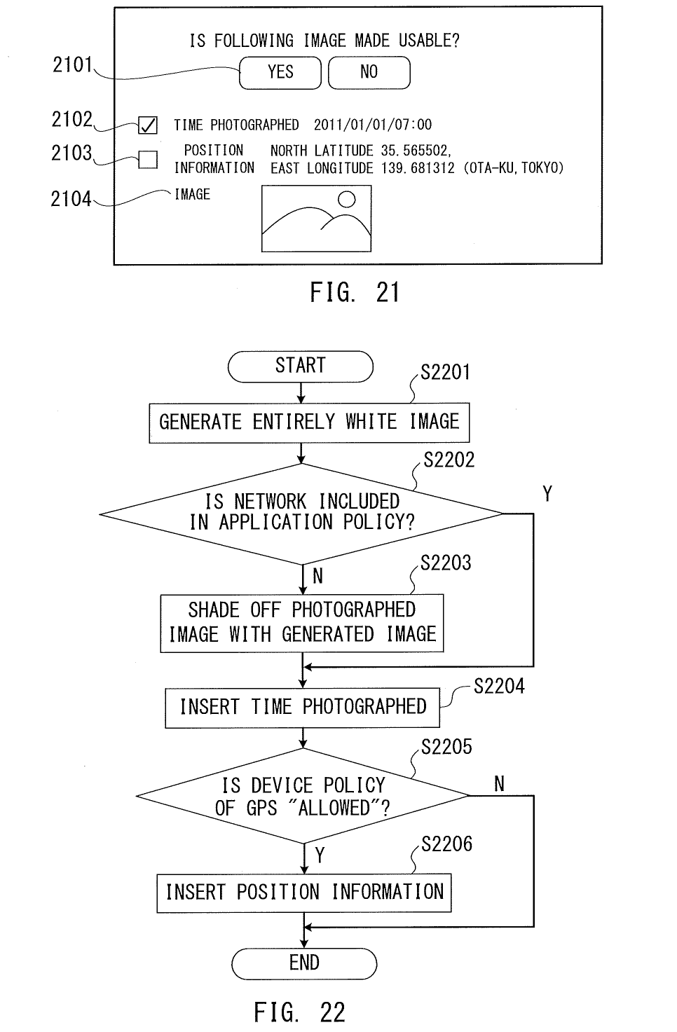

First, the CPU 1302 determines whether the image specified by the user is the dummy image or not (S8a01). The determination can be made based on whether the image is registered in the dummy image table shown in FIG. 19A. If it is determined that the image is the dummy image (S8a01:Y), it means that there are the encrypted actual image file and the first meta-information. Therefore, the CPU 1302 performs processing to decrypt the encrypted actual image file and the first meta-information (S8a02). FIG. 20B shows the procedure of the decryption processing. Referring the FIG. 20B, the CPU 1302 first decrypts the actual image (first data) and the meta-information (first meta-information) corresponding to the dummy image (S8b01). At this stage, the processing result is not yet passed to the application. This is because the fact that the specified image is found to be the dummy image means that the device policy of the photographing feature was “prohibited” at the time of photographing the image. It means that this may be the result of the photographing processing not desired by the user. Then, the CPU 1302 outputs the information prompting to input the instruction to the user independently of the application. In particular, a pop-up screen for confirmation as shown in FIG. 21 is displayed on the display unit 1308 to prompt the user to input the instruction (S8b02)

On the pop-up screen, button 2101 for “Yes” or “No” is displayed. This is to select “permission” or “rejection” of decryption. In addition, check boxes 2102 and 2103 are displayed on the screen to determine the meta-information to be included in the decrypted image. This complies the meta-information stored in the step of S6b03, i.e., the data shown in FIG. 19B. At this time, the meta-information with “allowed” device policy at the time of photographing is previously checked. Also, the meta-information with “prohibited” device policy at the time of photographing is previously unchecked. By doing so, it is expected to satisfy the user's desire and increase usability. Then, the CPU 1302 checks the check box of the meta-information with “allowed” device policy at the time of photographing (see FIG. 19B). Also, the CPU 1302 unchecks the check box of the meta-information with “prohibited” device policy at the time of photographing. As a result, the check box 2102 is checked and the check box 2103 is unchecked. If some instruction is input by the user, for example, if the decryption is allowed (S8b03: Y), the CPU 1302 embeds the meta-information selected by the user as an EXIF tag of JPEG. Then, the CPU 1302 outputs the information as the same file name as the dummy image, for example, as “IMG 0012.JPG”(S8b04). Thereafter, the CPU 1302 replaces the file with the dummy image. As a result, the first data, i.e., the actual image obtained in a feature restricted state of the apparatus is decrypted.

Back to FIG. 20A, the CPU 1302 uploads the actual image decrypted (S8a04). It is noted that the upload may be failed depending on a state of the network, server of an upload destination. Then, the CPU 1302 calls the successful call back if the upload is succeeded and if the CPU 1302 calls the error call back when the upload is failed. Then, the processing of the uploadImage function ends. In the step of S8a01, if it is determined that the specified image is not the dummy image (S8a01: N), the CPU 1302 immediately moves to the processing of S8a04.

As mentioned, to the access source to the second data, the CPU 1302 performs processing to present the second data and the second meta-information. On the other hand, to the access source to the first data, the CPU 1302 performs processing to present the first data and the first meta-information instructed by the user when presentation of the first data is enabled. The above processing allows photographing regardless of whether there is a feature restriction or not. However, to browse or move the image photographed in a feature restricted state (first data), it is always required to wait input of instruction by the user. As a result, it is possible to prevent data which is not confirmed by the user from being flown out. In addition, to realize the above processing, no special implementation is required to the application side.

It is noted that description has been given with regard to the example for encrypting the first data and the first meta-information in the fourth embodiment, however, in a case where the application is not available without permission or in a case where there is a storage area where no arbitrary access is allowed by the application, no encryption is required. For example, in an alternative embodiment, it is possible to store, from the beginning, the first data and the meta-information in a storage area having the tamper resistant. This is equivalent to giving the tamper resistant to the first data and the like.

Also, description has been given in the fourth embodiment on the assumption that, in whatever situation, the dummy image, having the same content, is generated. Alternatively, it is also possible to monitor the application usage and apply a different method of generating the dummy image depending on the monitoring result. The detail of the processing of the step S6a09 in FIG. 18 in this case is shown in FIG. 22. That is, the CPU 1302 generates a blank-state image i.e., a white image (S2201). Next, the CPU 1302 monitors whether the network is used by the application or not. That is, the CPU 1302 monitors whether or not the network is included in the device policy available to the application (S2202). If the network is not included (S2202: N), the CPU 1302 incorporates a shaded-off photographed image into the white image (S2203). On the other hand, if the network is included in the device policy (S2202: Y), the white image is kept unchanged. In either case, the photographing time is inserted in the image (S2204). Then, the CPU 1302 determines whether the device policy regarding the GPS is in the “allowed” state or not (S2205). If it is determined that the device policy is in the “allowed” state (S2205: Y), the CPU 1302 inserts the position information in the image (S2206).

In this example, depending on whether the network is used by the application or not, a different method to generate the dummy image is employed. This is because the network is the apparatus feature which outputs the photographed image (first data) outside the apparatus. When the network is not used by the application, the shaded-off photographed image is used. This is because, as compared to the dummy image comprising only of the time information (FIG. 17D), the shaded-off image is the image which recalls the photographed image and which is highly convenient for the user. On the other hand, when the network is used by the application, the white image is kept unchanged. This is to make the image irrelevant to the photographed image. The allowance/prohibition of GPS is in a trade-off relationship between the user's usability and security. If the GPS is “allowed” in the device policy, it is estimated that the position information is important for the user. As mentioned, the content of the dummy image to be generated is varied depending on the usage of the apparatus feature by the application. By doing so, the user's usability can be enhanced.

Description has also been given in the fourth embodiment with regard to the processing to decrypt the image encrypted by the uploadImage function. Other methods are also applicable to perform the decryption processing. An example of one of the other method includes, for example, monitoring the access to the dummy image by the JavaScript engine 1401 and performing the decryption processing when accessed by the application. In either case, the actual image can be decrypted by following the processing of FIG. 20B. Also, to enhance security in determining whether the decryption of the actual image is allowed or not, authentication processing, such as entering the password or fingerprint authentication may be added in the step of S8b03. Such a configuration enables to reduce risk of an outflow of the encrypted actual image even in a situation where, for example, the user lends the imaging device 1300 to others.

### Fifth Embodiment

Description has been given in the fourth embodiment with regard to the configuration and operation in a case where the imaging device 1300 is provided to the information processing apparatus. Instead, the information processing apparatus may be implemented as the information processing apparatus which stores data in which one or a plurality of sound, image and text are combined. When recording sound, instead of the imaging unit 1306 shown in FIG. 13, an apparatus comprising a recording unit is formed. To obtain and record the text or the image present on the network, an input device for obtaining such data may be provided. Data which is identical in configuration but different in contents as compared to the obtained data may be used as alternate data. The dummy image as described in the fourth embodiment may also be used.

[Data Management Method 2]

For either type of data as mentioned, the present invention can be implemented as data management method for reducing security risk by executing following processing. In this case, an apparatus in which an application which requests to obtain data and performs subsequent processing after obtaining the result of the request is installed is used. (1) Store the first data obtained in a format which allows no access by the application if the apparatus at the time of obtaining the data in accordance with the request is in a feature restricted state. (2) Generate data which will be alternative to the first data. Then, present the alternate data to the application. (3) Enable presentation of the first data after user's input of instruction associated with the presentation.

[Variation 2]

Descriptions have been given with regard to the examples of realizing the required features. In particular, in the first to the third embodiments, by executing the control computer by the CPU 101, and in the fourth embodiment, by executing the computer program by the CPU 1302 of the imaging device 1300, the required features are realized. It is noted, however, the embodiments of the present invention are not limited to such examples. For example, the embodiment of the present invention includes a case where, based on an instruction from a computer readable program, an OS running on a computer performs actual processing partly or entirely, and features of the embodiment are realized through the processing. The embodiment of the present invention also includes a case where processing is executed together with feature expansion board inserted into the computer or feature expansion unit connected to the computer and features of the embodiment are realized through the processing. Also, a program which realizes one or more features of each of the embodiment as mentioned may be supplied to a general-purpose computer via network or storage media. Then, the embodiment of the present invention may be realized in the processing in which one or more processors in the computer reads and executes the computer program. The present invention can be implemented by a circuit (for example, ASIC) which realizes one or more features. The computer program as mentioned and the storage media in which the computer program is stored are one embodiment of the present invention. The storage media includes flexible disk, external hard disk, optical disk, magneto-optical disk, CD-ROM, CD-R, optical magnetic disk, magnetic tape, nonvolatile memory card, ROM, and the like. As mentioned, in the present invention, data such as a photographed image obtained in a feature restricted state and data obtained in a state with no feature restriction are individually managed. As a result, it is possible to realize an information processing apparatus which can prevent execution of processing not intended by the user caused by the data obtained.

Also, according to the present invention, processing to be performed on data obtained in a feature or an operation restricted state is determined after an input of a predetermined instruction. Thereby, such data can separately be controlled from data obtained in a state with no such restriction. This enables, for example, to avoid execution of processing not intended by the user caused by the data obtained in the above-mentioned state.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2014-192442, filed Sep. 22, 2014 and 2014-203953, filed Oct. 2, 2014 which are hereby incorporated by reference wherein in their entirety.

What is claimed is:

1. An information processing apparatus capable of obtaining data in either a first state in which feature or operation is restricted or a second state in which the restriction is released, the information processing apparatus comprising:
a determining unit configured to determine whether the data is obtained in the first state or in the second state,
a storing unit configured to individually store first data obtained in the first state and second data obtained in the second state in a predetermined storage medium; and
a control unit configured to determine processing to be performed on data stored in the storage medium after an input of a predetermined instruction.

2. The information processing apparatus according to claim 1, wherein:
the first data represents a first photographed image obtained by an imaging unit which allows photographing by a user,
the second data represents a second photographed image obtained by the imaging unit in a state in which the restriction is released, and
the storing unit is further configured to store the first photographed image in a storage area where is different from where the second photographed image is stored.

3. The information processing apparatus according to claim 1,
wherein the storing unit is further configured to store information at the time of photographing, representing that the first photographed image is photographed in the first state, in relation with the first photographed image.

4. The information processing apparatus according to claim 2,
wherein the control unit is further configured to receive processing content to be executed on the first photographed image as the input of the instruction, to execute the processing content received, and to store information representing “processed” after executing the processing content in relation with the first photographed image.

5. The information processing apparatus according to claim 4,
wherein a first storing area for storing the first photographed image and a second storage area where is different from the first storing area are created in the storage medium, and
wherein the control unit is further configured to execute:
(1) processing to move the first photographed image stored in the first storing area to the second storage area; or
(2) processing to remove the first photographed image from the first storage area.

6. The information processing apparatus according to claim 5,
wherein the second storage area is assigned for each user, and the control unit is further configured to receive the input of the instruction for each user and execute processing to move the first photographed image to the second storage area assigned for the user.

7. The information processing apparatus according to claim 6, further comprising a managing unit configured to hold account information of a plurality of users who are allowed to log in,
wherein the control unit is further configured to compare the account information obtained before the apparatus turns to the first state and the account information obtained after the first state is released, and hold the processing to be performed on the first photographed image if the account information do not match.

8. The information processing apparatus according to claim 1,
wherein the first state is a state in which user's authentication is required when restarting the feature or operation of the imaging unit and the second state is a state in which the authentication is succeeded.

9. An imaging device which allows photographing by a user in either a first state in which feature or operation is restricted or in a second state in which the restriction is released, the imaging device comprising:
a determining unit configured to determine whether the imaging unit at the time of photographing is in the first state or in the second state;
a storing unit configured to individually store a first photographed image photographed when the imaging unit is in the first state and a second photographed image photographed when the imaging unit is in the second state in a predetermined storage medium;
a display unit configured to display an operation screen for operating the first photographed image;
a control unit configured to receive processing content to be executed on the first photographed image input by the user through the operation screen and to execute the processing content received.

10. An information processing apparatus comprising:
a giving unit configured to give tamper resistant to first data obtained in a feature restricted state;
a generation unit configured to generate alternate data, which is alternative to the first data;
a control unit configured to present the alternate data to an access source to the first data and enable presentation of the first data after an input of an user's instruction associated with the presentation;
a memory unit configured to separately store the second data obtained in a state with no feature restriction from the first data; and
a meta-information obtaining unit configured to obtain first meta-information accompanying the first data or second meta-information accompanying the second data,
wherein the control unit is further configured to present the second data and the second meta-information to an access source to the second data, wherein, to the access source to the first data, the first data and the first meta-information instructed by the user are presented when presentation of the first data is enabled.

11. The information processing apparatus according to claim 10,
wherein the giving unit is further configured to give the tamper resistant to the first data by encrypting the first data using key information to which no access from the access source is allowed.

12. The information processing apparatus according to claim 10,
wherein the giving unit is further configured to give the tamper resistant to the first data by storing the first data in a storage area to which no access from the access source is allowed.

13. The information processing apparatus according to claim 10,
wherein the access source represents an application which requests to obtain the first data or the second data and executes subsequent processing after obtaining result of the request, and
wherein the control unit is further configured to output the information prompting to input the instruction to the user independently of the application after presenting the alternate data to the application in response to the request to obtain the first data.

14. The information processing apparatus according to claim 13, further comprising:
a policy holding unit configured to hold security policy for defining apparatus features which are available/unavailable to the application,
wherein the generation unit is further configured to vary the content of the alternate data to be generated depending on the security policy.

15. The information processing apparatus according to claim 14,
wherein the generation unit is further configured to generate dummy image which recalls the first data as the alternate data in a case where use of the apparatus feature to output the first data outside the apparatus is not allowed by the security policy.

16. The information processing apparatus according to claim 14,
wherein the generation unit is further configured to generate dummy image which is irrelevant to the first data as the alternate data in a case where use of the apparatus feature to output the first data outside the apparatus is allowed by the security policy.

17. The information processing apparatus according to claim 16,
the generation unit is further configured to generate a shaded-off photographed image as the alternate data.
